(19) United States
(12) Patent Application Publication
(10) Pub. No.: US 2004/0130113 A1
(43) Pub. Date: Jul. 8, 2004

(54) Segmented cart for storage and transport of container doors

(76) Inventors: Mark A. Iwanicki, Belchertown, MA (US); Jack M. Willard, Enfield, CT (US); Michael W. Boyington, Chicopee, MA (US)

Correspondence Address: Mark A. Iwanicki, 77 PONDVIEW CIRCLE, BELCHERTOWN, MA, 01007, US

(21) Appl. No.: 10/337,941

(22) Filed: Jan. 6, 2003

(51) Int. Cl. B62B 3/00

(52) U.S. Cl. 280/47.34

(57) ABSTRACT

A utility cart is described which includes a right side retainer, a left side retainer, a base and a plurality of dividers for retaining elongate structures.

### BACKGROUND OF THE INVENTION

1. Field of the Invention

The present invention is directed to a movable cart having segments designed to store and transport a plurality of transport container doors.

2. Detailed Description of Prior Art

Carts and containers used for storing and transporting various items are known. See for example U.S. Pat. No. 5,011,240, U.S. Pat. No. 4,512,473, U.S. Pat. No. 5,028,062, U.S. Pat. No. 5,871,219, U.S. Pat. No. 5,876,047, and U.S. Pat. No. 6,293,568. However, prior art carts and containers are not configured to store and transport vertically arranged items, such as shipping container doors, which are often cumbersome to transport. Accordingly, there is a need in the art for a utility cart having structure to vertically support, store and transport a plurality of shipping container doors.

Accordingly, it is an object of the present invention to provide a moveable cart capable of supporting, storing and easily transporting storage container doors. It is a further object of the present invention to provide a cart that is capable of vertically supporting a plurality of storage container doors in horizontal series. It is an additional object of the present invention to provide a cart that can be used to easily transport a plurality of storage container doors vertically supported in horizontal series. Particular objects and advantages of the invention will be apparent to those skilled in the art, that is, those who are knowledgeable or experienced in this field of technology, in view of the following disclosure of the invention and detailed description of certain preferred embodiments.

### SUMMARY

Embodiments of the present invention may be used to advantageously provide a utility cart capable of supporting a plurality of items in an upright or vertical position. The items are also positioned on the cart adjacent to one another in a horizontal or series relation. According to one embodiment of the present invention, the cart includes a base portion having a front edge, back edge, left edge and right edge and to which is attached a set of wheels that are used to move the cart in any desired direction. The cart further includes a left side retainer attached to the left edge and a right side retainer attached to right edge. Dispersed in series between the left side portion and right side portion are a plurality of divider portions that serve to segment the cart into a plurality of segments. Each segment has a dimension sufficient to receive an elongate structure, such as a shipping container door.

According to an additional embodiment of the present invention, a method is provided whereby elongate structures are organized, stored and easily transported. According to the method of the present invention, a cart is provided that has a base portion having a front edge, back edge, left edge and right edge and to which is attached a set of wheels that are used to move the cart in any desired direction. The cart further includes a left side retainer attached to the left edge and a right side retainer attached to right edge. Dispersed in series between the left side retainer and the right side retainer are a plurality of dividers that serve to segment the cart into a plurality of segments. Each segment has a dimension sufficient to receive an elongate structure, such as a shipping container door. The elongate structures are then inserted into a corresponding segment in a vertical manner. Each elongate structure is supported within the cart by the two dividers between which the elongate structure is inserted. Once a desired number of elongate structures are placed into the cart, the elongate structures are then transported to a desired destination for relocation, storage or other desired purpose.

From the foregoing disclosure, it will be readily apparent to those skilled in the art, that is, those who are knowledgeable or experienced in this area of technology, that the present invention provides a significant technological advance. Preferred embodiments of a utility cart of the present invention can enhance the organization, transport and storage of shipping container doors that otherwise would remain disorganized.

These and additional features and advantages of the invention disclosed here will be further understood from the following detailed disclosure of certain preferred embodiments.

### BRIEF DESCRIPTION OF THE DRAWINGS

Certain preferred embodiments are described in detail below with reference to the appended drawings wherein:

FIG. 1 is a front view of the utility cart of the present invention showing the segments into which elongate objects, such as doors, may be placed for transport or storage.

FIG. 2 is a side view of the utility cart of FIG. 1.

### DETAILED DESCRIPTION OF CERTAIN PREFERRED EMBODIMENTS

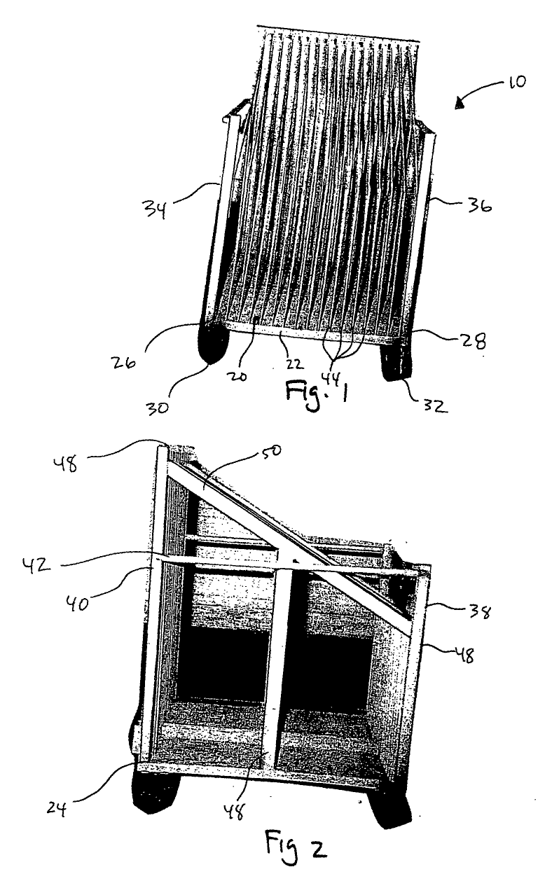

Referring to FIG. 1, a utility cart 10 according to the present invention is shown in a front view to have a base portion 20 having a front edge 22, a back edge 24, a left side edge 26 and a right side edge 28. Front wheels 30 and 32 and a corresponding pair of back wheels are attached at each corner of base 20 to allow easy movement of the utility cart. Wheels 30 and 32 are commercially available swivel-type wheels that advantageously allow the utility cart to move in any desired direction. According to one embodiment of the present invention, the front wheels may be a swivel-type while the back wheels are fixed to allow for easy directional movement of the utility cart. The wheels are selected to operate under the maximum load of the utility cart, which may vary according to the structures placed into the cart. For example, if the elongate structures are metal doors having considerable weight, then a wheel capable of supporting a significant amount of weight is selected. If the elongate structures are wood doors weighing less than metal doors, then the wheels need not operate to the same weight specification.

As can be seen in FIG. 1, utility cart 10 has a left side retainer 34 and a right side retainer 36. In a preferred embodiment the right side retainer 36 is mounted to the right edge of the base and a back section (not shown) of the utility cart. Left side retainer 34 is mounted to the left edge of the base and the back section. The right side retainer, left side retainer, base and back section may also be a unitary structure. The unitary structure may be configured to form a frame to retain the elongate structures therein.

The left side retainer, as seen in FIG. 1, and also in FIG. 2, includes a front post 38 and a back post 40. Connecting the posts is brace 42 which may also serve as a handle for moving the cart. The right side retainer also includes a front post and a back post and a brace which may also serve as a handle for moving the cart. The right and left side retainers, as well as the back section, may also be solid walls. The right side retainer, left side retainer and back section may be connected to together and to the base by conventional methods such as welding, bracketing, slide inserts, screws, nut and bolt configurations and the like.

As can be further seen in FIG. 1, a plurality of dividers 44 are positioned between the right side retainer and the left side retainer thereby creating a plurality of segments. As can be seen more clearly in FIG. 2, each divider 44 includes three vertical posts 48 which increase in height from the front of the utility cart to the back of the utility cart. The three posts 48 are connected at their top sections by a brace 50 which is observed in FIG. 2 as being angled upward from the front of the utility cart to the back of the utility cart. The divider is secured to the utility cart at the back section and at positions on the base 20 where the base contacts the posts. The divider may also be formed from posts of equal height. The height configuration of the divider is such that it is capable of providing sufficient support for an elongate structure, such as a door, without the elongate structure tipping over the divider. The angled configuration of the divider advantageously provides support for elongate structures, such as doors, without requiring the additional material necessary to manufacture a divider having posts of equal height. As with the right and left side retainers and the back section, the dividers may also be solid walls. The dividers, which may be fixed or removable, may be connected to the utility cart by conventional methods such as welding, bracketing, slide inserts, screws, nut and bolt configurations and the like.

According to one particular embodiment of the present invention, the utility cart includes between 4 and 15 dividers. The dividers may be equally spaced or they may be spaced to accommodate elongate structures of various widths. In addition, the dividers may be removable from the base which has receivers for receiving the dividers. The receivers may be grooves or slots in the base or they may be bracket structures into which the dividers are fitted and removably secured. Any number of dividers can be placed into a base to allow for diversity in the number and thickness of items to be transported. Accordingly, segments of a plurality of various widths may be created to allow the insertion, transportation and/or storage of elongate structures of various thicknesses. For example, a few dividers may be spaced a first distance apart creating a first segment width. The remaining dividers may be positioned a second distance apart creating a second segment width. Elongate structures of various thicknesses are then more easily accommodated by the utility cart due to the different widths of the segments.

The utility cart of the present invention can be manufactured according to convention methods and from conventional materials including metal, wood, plastic, fiberglass, other durable materials and combinations thereof. In general, the utility cart of the present invention is designed from materials that can withstand wear and tear from metal doors having significant weight, such as those commonly used with metal bulk shipping containers.

According to a particular embodiment of the present invention, a method of transporting elongate structures such as metal doors is provided. According to the method of the present invention, a utility cart is provided that has a base, a right side retainer and a left side retainer and a plurality of dividers forming a plurality of segments that are configured to retain the elongate structures in a vertical manner. The dividers are spaced apart on the utility cart to allow for the horizontal, in series placement of a plurality of elongate structures. According to one embodiment of the present method invention, the elongate structures are inserted into corresponding segments and retained within the utility cart by means of the base and dividers and right and left side retainers where appropriate. The elongate structures are then moved about by way of the utility cart and transported to a desired location.

In light of the foregoing disclosure of the invention and description of the preferred embodiments, those skilled in this area of technology will readily understand that various modifications and adaptations can be made without departing from the true scope and spirit of the invention. All such modifications and adaptations are intended to be covered by the following claims.

1. A utility cart comprising:
a base;
a right side retainer;
a left side retainer; and
a plurality of dividers disposed between the right side retainer and the left side retainer creating a plurality of segments into which elongate structures are disposed.

2. The utility cart of claim 1 further including wheels attached to the base.

3. The utility cart of claim 2 wherein the dividers are disposed at equal distances along the base.

4. The utility cart of claim 2 wherein the dividers are disposed at a plurality of different distances along the base.

5. The utility cart of claim 1 further including a back section.

6. The utility cart of claim 5 wherein the dividers angle downward from the back section of the utility cart.
